(19) United States
(12) Patent Application Publication
(10) Pub. No.: US 2019/0107931 A1
(43) Pub. Date: Apr. 11, 2019

(54) INFORMATION PROCESSING APPARATUS, INFORMATION PROCESSING METHOD, AND COMPUTER READABLE MEDIUM

(71) Applicant: TOSHIBA TEC KABUSHIKI KAISHA, Tokyo (JP)

(72) Inventor: Yosuke ISONO, Tagata Shizuoka (JP)

(21) Appl. No.: 16/130,746

(22) Filed: Sep. 13, 2018

(30) Foreign Application Priority Data
Oct. 6, 2017 (JP) 2017-195944

(51) Int. Cl. G06F 3/0484; G06F 3/0482; G06F 17/24

(52) U.S. Cl. CPC G06F 3/0484; G06F 17/24; G06F 3/0482

(57) ABSTRACT

An information processing apparatus includes an input device, a display, and a processor configured to control the display to display a graphical user interface (GUI) including a first GUI element selectable for transmitting a message and a second GUI element for switching a first state where the first GUI element is operable and a second state where the first GUI element is not operable, control the input device to accept a user input for switching the first and the second state on the second GUI element, and control the display to display the first GUI element as being not operable in the second state.

### CROSS-REFERENCE TO RELATED APPLICATIONS

This application is based upon and claims the benefit of priority from Japanese Patent Application No. 2017-195944, filed on Oct. 6, 2017, the entire contents of which are incorporated herein by reference.

### FIELD

Embodiments described herein relate generally to an information processing apparatus, an information processing method, and a computer readable medium.

### BACKGROUND

In the related art, an electronic mail (e-mail) is widely used. The e-mail system is achieved by a function of exchanging electronic data including a message between information processing apparatuses, such as personal computers (hereinafter referred to as PCs), mobile phones, and other smart devices, through a network such as the Internet. Hereinafter, for distinction, the function to achieve the e-mail system is referred to as “e-mail function”, and the exchanged information or message is simply referred to as “e-mail”. The information processing apparatus transmits or receives an e-mail to or from another apparatus using dedicated software.

As the above-described software, in addition to dedicated application software (referred to as mail software or a mailer), a web-based e-mail system (referred to as web mail) using a web browser is known. In the related art, various studies for preventing erroneous or inadvertent e-mail transmission are proposed in both the mail software and the web mail.

For example, there is a technique of displaying a dialog box for calling attention to a user when he or she presses a transmission button displayed on the screen. For example, the dialog box displays a message that encourages the user to confirm whether the specified e-mail address or attached file is correct.

However, in some cases, the related art as described above may be inconvenient to the user, and the erroneous transmission may not be prevented completely. For example, the additional dialog box displayed after pressing the transmission button would bother users who are accustomed to the existing e-mail system. Such users may ignore the displayed message and just close the dialog box. On the other hand, users who are unfamiliar with the e-mail system may be upset by the dialog box suddenly displayed after his or her regular operation.

### DESCRIPTION OF THE DRAWINGS

FIG. 1 is a diagram schematically illustrating a configuration of a system that realizes an e-mail function of an embodiment;

FIG. 2 is a block diagram schematically illustrating a configuration of a client apparatus;

FIG. 3 is a block diagram illustrating functional units realized by a controller activating mail software;

FIG. 4 is a diagram illustrating an example of a UI of the mail software;

FIG. 5 is a diagram illustrating an example of the UI in a transmission permission state;

FIG. 6 is a flowchart illustrating a flow of an edit screen display processing;

FIG. 7 is a flowchart illustrating a flow of a transmission permission or prohibition change processing;

FIG. 8 is a flowchart illustrating a flow of the transmission processing;

FIG. 9 is a diagram illustrating a GUI element used in an embodiment; and

FIGS. 10A and 10B are diagrams each illustrating a GUI element used in an embodiment.

### DETAILED DESCRIPTION

An embodiment provides an information processing apparatus capable of further preventing erroneous transmission of an e-mail.

In general, according to one embodiment, an information processing apparatus comprises an input device, a display, and a processor configured to control the display to display a graphical user interface (GUI) including a first GUI element selectable for transmitting a message and a second GUI element for switching a first state where the first GUI element is operable and a second state where the first GUI element is not operable, control the input device to accept a user input for switching the first and the second state on the second GUI element, and control the display to display the first GUI element as being not operable in the second state.

### First Embodiment

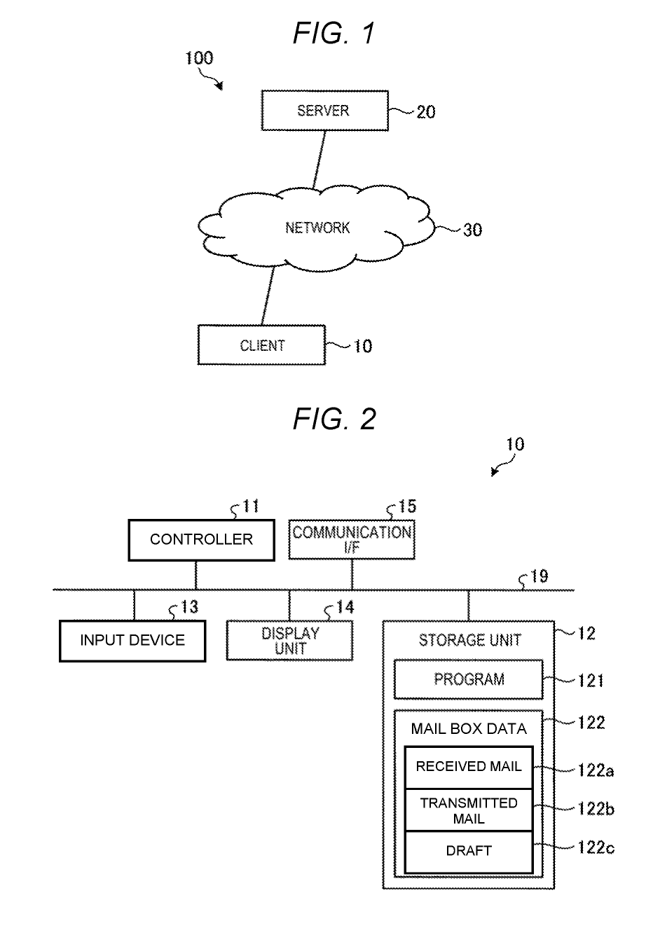

An embodiment will be described with reference to the drawings. FIG. 1 is a diagram schematically illustrating a configuration of a system 100 that realizes an e-mail function. The system 100 is an example of an e-mail system and includes at least a client apparatus 10 (hereinafter called “client”), a server apparatus 20 (hereinafter called “server”), and a network 30.

The client 10 is an example of an information processing apparatus and is operated by a user of the e-mail function. The client 10 of an embodiment is a Personal Computer (PC). In implementation, the client 10 may be a terminal device such as a tablet PC or a smart phone.

The client 10 displays on the display a User Interface (UI) for a user (i.e., an operator of the client 10) to read, edit, transmit, and receive e-mails. The operator reads and edits the e-mail using the UI. In addition, the operator instructs the UI to execute transmission and reception of the e-mail.

The server 20 is a mail server and manages the transmission and reception of the e-mail through the network 30. For example, the server 20 is realized by the information processing apparatus of a computer configuration including a controller or a storage unit.

For example, the network 30 is the Internet, a Virtual Private Network (VPN), or the like. The server 20 and the client 10 are connected with each other so as to be able to communicate with each other through the network 30.

Although FIG. 1 shows one client 10, one server 20, and one network 30, this is a simple example, and any number of clients 10, servers 20, and networks 30 may be used to achieve the e-mail function.

FIG. 2 is a block diagram schematically illustrating a configuration of the client 10. The client 10 includes a controller 11, a storage unit 12, an input device 13, a display unit 14, a communication interface (I/F), and a bus 19. The bus 19 is a data bus, an address bus, or the like and mutually connects each component (the controller 11, the storage unit 12, the input device 13, the display unit 14, and the communication I/F 15). Each component exchanges signals through the bus 19.

For example, the input device 13 is a keyboard, a mouse, or a touch panel. For example, the display unit 14 is a display device such as a liquid crystal display. The communication I/F 15 is an interface through which the controller 11 communicates with another device such as the server 20 through the network 30.

The controller 11 includes a Central Processing Unit (CPU), a Read Only Memory (ROM), and a Random Access Memory (RAM). The CPU comprehensively controls an operation of the client 10. The ROM is a non-volatile memory device that stores various programs or data. The RAM is a volatile memory device that temporarily stores various programs or various pieces of data. The CPU executes a program stored in the ROM, the storage unit 12, or the like using the RAM as a work area.

The storage unit 12 is a storage device such as a Hard Disk Drive (HDD) or a Solid State Drive (SSD). The storage unit 12 stores a program 121 and a mail box data 122. The program 121 is an operating system or a control program for implementing various functions of the client 10.

The program 121 includes programs for implementing a characteristic function according to an embodiment and one of the programs is mail software. The mail software is application software for the user to transmit, receive, and edit e-mails. The controller 11 realizes the e-mail function by activating the mail software.

The mail box data 122 includes data for e-mails transmitted to or received from another user. The e-mails in the mail box data 122 are classified into a received mail 122a, a transmitted mail 122b, a draft 122c, and the like. The received mail 122a is an e-mail received from the outside. The transmitted mail 122b is an e-mail transmitted to the outside. The draft 122c is an e-mail that is created but has not been transmitted.

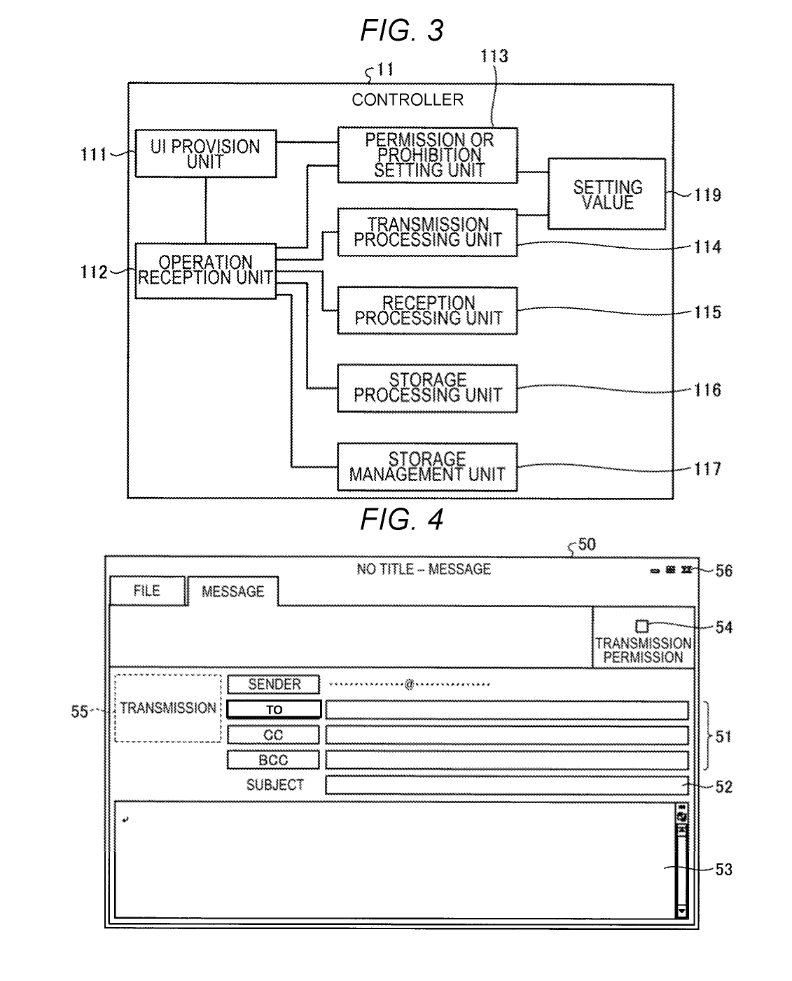

FIG. 3 is a block diagram illustrating functional units realized by the controller 11 activating the mail software. The functional units include a UI provision unit 111, an operation reception unit 112, a permission or prohibition setting unit 113, a transmission processing unit 114, a reception processing unit 115, a save processing unit 116, a storage management unit 117, and the like. The mail software includes a user interface provision unit, a permission or prohibition setting unit, and a transmission unit. The user interface provision unit, the permission or prohibition setting unit, and the transmission unit cause the controller 11 executing the user interface provision unit, the permission or prohibition setting unit, and the transmission unit to function as the UI provision unit 111, the permission or prohibition setting unit 113, and the transmission processing unit 114, respectively.

The UI provision unit 111 controls the display unit 14 to display the UI. The operation reception unit 112 controls the input device 13 to receive an operation performed by a user on the UI.

FIG. 4 is a diagram illustrating an example of a UI 50 of the mail software. The UI 50 of an embodiment is a window type Graphical User Interface (GUI) and is a screen for a user to edit an e-mail. Generally, the screen is displayed on a main screen of the mail software when the user operates a GUI element (e.g., a button) for creating a new e-mail, replying to an e-mail from another user, transmitting a new e-mail, or the like.

The UI 50 includes a destination input field 51, a subject input field 52, a message body field 53, a check box 54, a transmission button 55, an end button 56, and the like.

The destination input field 51 is a field for a user to input a designation address through the input device 13 and display the input destination. The subject input field 52 is a field for the user to input a subject of the e-mail through the input device 13 and display the input subject. The message body field 53 is a field for the user to input and edit the message body of the e-mail through the input device 13 and displays the input characters and the like.

The check box 54 allows the user to enable and disable a transmission button 55 for transmitting the e-mail through the input device 13. The transmission button 55 allows the user to transmit the e-mail to the input destination address through the input device 13.

The end button 56 allows the user to close the UI 50 through the input device 13. When the end button 56 is pressed, the controller 11 closes the UI 50, that is, controls the display unit 14 not to display the UI 50 in the display screen and display the main screen of the mail software.

Here, the check box 54 and the transmission button 55 are disposed to be spaced from each other. In an embodiment, one of the check box 54 and the transmission button 55 is disposed in one side portion of the UI 50 and the other is disposed in the other side of the UI 50. More specifically, the check box 54 is disposed in the right end portion of the UI 50, and the transmission button 55 is disposed in the left end portion of the UI 50. This configuration advantageously reduces the chances of erroneous operation about the check box 54 and the transmission button 55.

Returning to FIG. 3, the permission or prohibition setting unit 113 sets the permission or prohibition of the transmission of the e-mail, and when the UI 50 receives a predetermined operation, the permission or prohibition setting unit 113 sets a setting value of the permission or prohibition of the transmission of the e-mail to one of “permitted” and “prohibited”. In an embodiment, the predetermined operation described above is an operation performed on the check box 54. The permission or prohibition setting unit 113 receives a signal corresponding to the operation received by the check box 54 of the UI 50 through the operation reception unit 112.

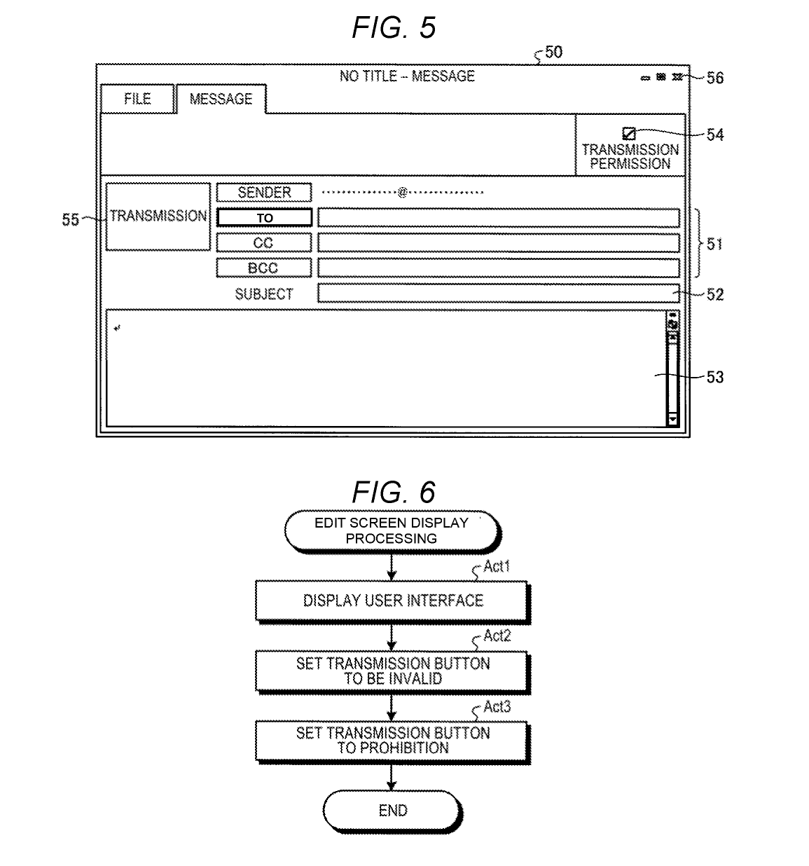

When an operation of inputting a check mark in the check box 54 is performed such as clicking the check box 54 without a check mark, the permission or prohibition setting unit 113 sets the setting value of the permission or prohibition of the transmission of the e-mail to “permitted”. FIG. 5 is a diagram illustrating an example of the UI 50 in a transmission permitted state.

When an operation of removing the check mark is performed such as clicking the check box 54 with the check mark, the permission or prohibition setting unit 113 sets the setting value of the permission or prohibition of the transmission of the e-mail to “prohibited”. The UI 50 shown in FIG. 4 is in a transmission prohibited state.

In an embodiment, the setting value of the permission or prohibition of the transmission of the e-mail described above is stored in the RAM of the controller 11. The permission or prohibition setting unit 113 maintains the setting value of the permission or prohibition of the transmission in a region 119 of the RAM from when the UI 50 is displayed until the UI is closed, and when the check box 54 receives the operation, the permission or prohibition setting unit 113 updates the setting value. An initial value of the setting value (a value when the check box 54 is not checked after the UI 50 is activated) is “prohibited”, and a state of the check box 54 at the same timing (an initial state) is without the check mark. The initial value of the setting value is written in the region 119 of the RAM by, for example, the permission or prohibition setting unit 113.

Here, when the controller 11 closes the UI 50 during the edit of the e-mail, the e-mail is saved in the mail box data 122 as the draft 122c, and the region 119 of the RAM in which the setting value of the permission or prohibition of the transmission of the e-mail is stored is released. When the e-mail of the draft 122c is opened again, the UI 50 is newly displayed, and in the UI 50, the setting value of the permission or prohibition of the transmission is set to the initial value, that is, “prohibited”. That is, even though the check box 54 is checked and the setting value is set to “permitted” during the previous edit, the value is not saved with the draft 122c and reset to “prohibited” at the time of re-editing.

The permission or prohibition setting unit 113 further changes the appearance of the transmission button 55 by working on the UI provision unit 111 according to the setting value of the permission or prohibition of the transmission of the e-mail. Therefore, a user can visually recognize whether the setting value is set to “prohibited” or “permitted”.

For example, when the setting value is set to “prohibited”, the transmission button 55 has an appearance indicating that the button is disabled or inoperable. An example of the appearance is as shown in FIG. 4. Alternatively, the disabled transmission button 55 may be indicated by a grayed out button or the like.

When the setting value is set to “permitted”, the transmission button 55 has an appearance indicating that the button is enabled or operable. The transmission button 55 shows normal appearance, and an example thereof is shown in FIG. 5. Therefore, the user can visually recognize that the transmission button 55 is operable.

When the UI 50 receives a predetermined operation, the transmission processing unit 114 checks the setting value of the permission or prohibition of the transmission of the e-mail with reference to the region 119 of the RAM, and executes the transmission processing in the “permitted” state. In the transmission processing, the e-mail is transmitted to the server 20 through the communication I/F 15 and the network 30.

Here, in an embodiment, the predetermined operation described above is an operation performed on the transmission button 55. The transmission processing unit 114 receives a signal corresponding to the operation received by the transmission button 55 of the UI 50 through the operation reception unit 112. When the setting value of the permission or prohibition of the transmission of the e-mail is “prohibited”, the transmission processing unit 114 does nothing.

The reception processing unit 115 executes reception processing when the mail software is activated or when the reception of the operation by the GUI element (the button or the like) for instructing the reception of the e-mail displayed on the main screen of the mail software is transferred by the operation reception unit 112. In the reception processing, the reception processing unit 115 controls the communication I/F 15 to receive the e-mail transmitted from the server 20 through the network 30.

When the input device 13 receives a predetermined operation, the save processing unit 116 saves the e-mail during the edit, that is, the e-mail edited in the message body field 53 before the transmission in the mail box data 122 as the draft 122c. Here, for example, the predetermined operation is an input of a predetermined command (for example, [Ctrl] key+[S] key) or a click of an overwrite button (not shown). In closing the UI 50, the save processing unit 116 saves the e-mail during the edit in the mail box data 122 as the draft 122c.

The storage management unit 117 manages the local mail box data 122, for example, deletes the e-mails specified by the user.

FIG. 6 is a flowchart illustrating a flow of an edit screen display processing. The controller 11 executes the processing when the GUI element for instructing the new creation, the reply, or the transmission of the e-mail on the main screen of the mail software is operated by the user. In the processing, the controller 11 controls the display unit 14 to display the UI 50 (Act 1), invalidates the transmission button 55 (Act 2), and sets the setting value of the permission or prohibition of the transmission of the e-mail to “prohibited” (Act 3). According to Act 2, the controller 11 sets the appearance of the transmission button 55 to the appearance indicating that the operation is invalid such as a grayed out button.

Here, the flowchart shown in FIG. 6 is merely an example, and in implementation, Acts 2 and 3 may be reversed or may be performed at the same time. For example, when the setting value of the permission or prohibition of the transmission of the e-mail is related to the operation validity or operation among properties of the transmission button 55, Acts 2 and 3 are completed at the same time. When the property related to the validity or invalidity of the transmission button 55 and the property related to the appearance (normal or grayed out) are associated with each other, the appearance is automatically changed according to the changed setting value. In any case, immediately after the UI 50 is displayed, the setting value of the permission or prohibition of the transmission of the e-mail is preferably set to “prohibited” in a state in which the operation of the transmission button 55 is invalid.

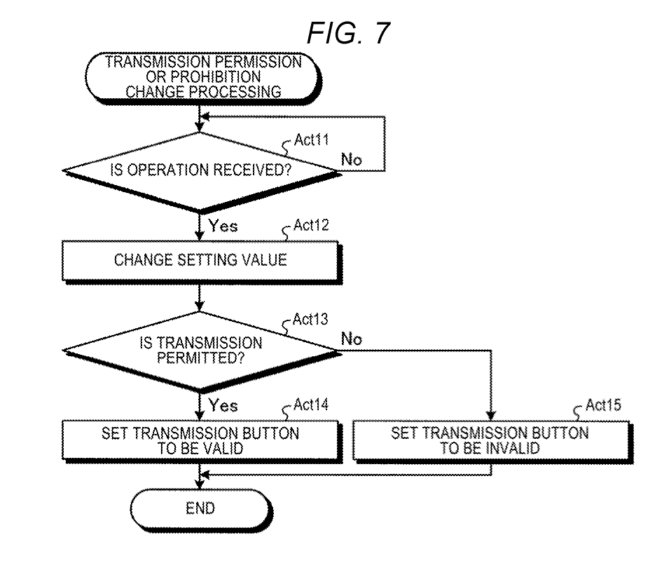

FIG. 7 is a flowchart illustrating a flow of a transmission permission or prohibition change processing. The controller 11 waits for the operation on the check box 54 (No in Act 11), and when the check box 54 receives the operation (Yes in Act 11), the controller 11 changes the setting value of the permission or prohibition of the transmission of the e-mail (Act 12). Next, when the changed setting value indicates the transmission is permitted (Yes in Act 13), the controller 11 sets the operation of the transmission button 55 to be valid (Act 14). The controller 11 changes the appearance of the transmission button 55 from the grayed out button to the normal appearance together with the processing in Act 14.

In Act 13, when the changed setting value indicates the transmission is prohibited (No in Act 13), the controller 11 sets the operation of the transmission button 55 to be invalid (Act 15). The controller 11 changes the appearance of the transmission button 55 from the normal appearance to the grayed out button together with the processing in Act 15.

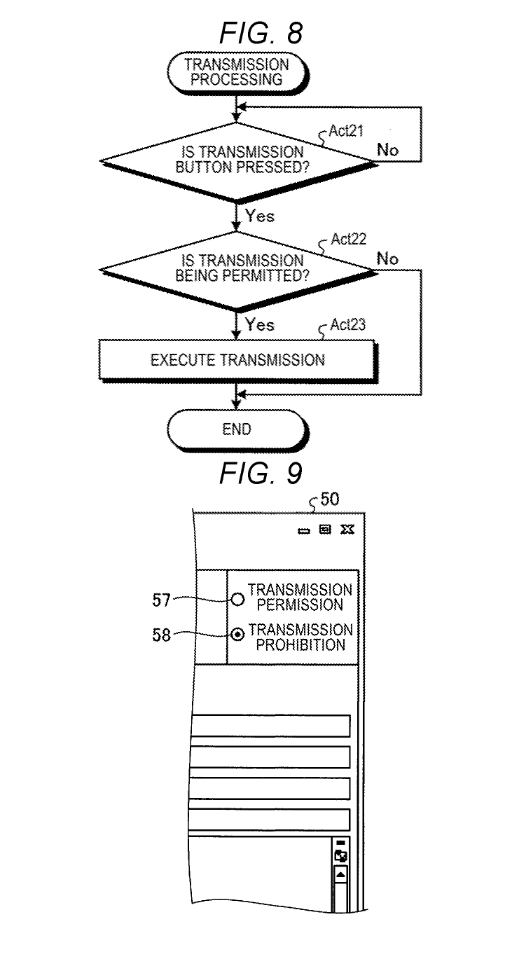

FIG. 8 is a flowchart illustrating a flow of the transmission processing. The controller 11 waits for the pressing of the transmission button 55 (No in Act 21), and when the transmission button 55 receives the operation (i.e., the button is pressed) (Yes in Act 21), the controller 11 checks whether the setting value of the permission or prohibition of the transmission of the e-mail indicates the transmission is permitted (Act 22). When the transmission is permitted (Yes in Act 22), the controller 11 executes the transmission (Act 23). In Act 22, when the setting value of the permission or prohibition of the transmission of the e-mail indicates the transmission is prohibited (No in Act 22), the controller 11 ends the present processing.

In such a configuration, when a user activates the mail software, the main screen is displayed. On the main screen, when the user operates the GUI element to create a new e-mail, reply to an e-mail from another user, or transmit an e-mail, the UI 50 is displayed. Immediately after the display of the UI 50, the operation of the transmission button 55 is invalid. When the user checks the check box 54, the operation of the transmission button 55 becomes valid. When the user presses the transmission button 55, the transmission processing is executed only when the operation of the transmission button 55 is valid. The e-mail transmitted from the client 10 is transmitted through the server 20 to a server that manages an e-mail address designated by the destination input unit 51.

As described above, according to an embodiment, the information processing apparatus is capable of further preventing erroneous transmission of the e-mail.

In an embodiment, pressing the transmission button 55 is possible only when the setting value of the permission or prohibition of the transmission of the e-mail indicates the transmission is permitted. The initial value of the setting value indicates the transmission is prohibited, and thus the operation of the transmission button 55 is invalid. Therefore, before pressing the transmission button 55, the user needs to perform an operation for permitting the transmission.

Compared with the aforementioned embodiments, in the example of the related art, a dialog box for calling attention to the user appears after the user presses the transmission button. In this case, the user feels troublesome or is surprised by the unexpected appearance of the dialog box for calling attention, although the user thinks that the transmission is executed after the user decides to perform the transmission. Therefore, a determination without calmness may be made by the user as compared with a case where a separate operation for the permission or prohibition of the transmission is required.

On the other hand, in an embodiment, when the setting of the permission or prohibition of the transmission is intentionally performed, the setting on the permission or prohibition of the transmission can be easily made by the user in a calm way. Therefore, according to an embodiment, possibilities of the erroneous transmission can be reduced as compared with the related art. That is, according to an embodiment, an effect of preventing the erroneous transmission can be improved.

In the software of the related art, since the operation of the transmission button does not become invalid, when the destination address is input by the user, the e-mail may be erroneously transmitted during the edit due to a reason such as unintentional pressing of the transmission button by mistake in some cases. Such erroneous transmission is likely to occur when editing a reply mail in which the destination is already set.

On the other hand, according to an embodiment, since the operation of the transmission button 55 is invalid without the predetermined operation, an erroneous transmission accident such as merely pressing the transmission button by mistake can be prevented. Since the transmission button is usually larger than other GUI elements, it is considered that the initial state set to the operation invalidation is effective to eliminate the erroneous transmission.

According to an embodiment, since the setting value of the permission or prohibition of the transmission is reset to “prohibited” (i.e., the initial value) when a user re-edits the e-mail saved in the draft 122c, it is effective to eliminate the erroneous transmission as compared with the related art. In the related art, the setting value changed to “permitted” at the time of the previous edit is saved and is reproduced on the UI displayed at the time of the re-edit.

According to an embodiment, since the check box 54 is disposed at a position spaced from the transmission button 55, the risk of the erroneous input to the check box 54 can be reduced, and reliability of the setting of the permission or the prohibition of the transmission can be improved by the disposition.

In an embodiment, since the check box 54 and the transmission button 55 are displayed in different appearances between when the setting value of the permission or prohibition of the transmission of the e-mail is set to “prohibited” and when the setting value of the permission or prohibition of the transmission of the e-mail is set to “permitted”, whether the transmission is prohibited or permitted can be visually recognized by the user. In an embodiment, the appearances of the both of the check box 54 and the transmission button 55 are changed according to the setting value, however, in implementation, only one of the check box 54 and the transmission button 55 may be changed.

### Second Embodiment

The second embodiment will be described below. Since the present embodiment is a modification example of the first embodiment, the description of the same parts as the first embodiment will be omitted, the parts different from the first embodiment will be described, and in the description, the same reference numerals are used for those already described in the first embodiment.

First, FIG. 9 is a diagram illustrating a GUI element used in the second embodiment. Instead of the check box 54 in the first embodiment, two radio buttons 57 and 58 may be used.

When the radio button 57 is pressed by a user, the radio button 57 turns ON (True). When the radio button 58 is pressed by the user, the radio button 58 turns ON (True). When one of the radio buttons 57 and 58 is pressed, the one receiving the operation turns ON and the other turns OFF (False). In the initial state of the UI 50, the radio button 58 of the transmission prohibition is ON.

Whenever the radio buttons 57 and 58 are pressed, the permission or prohibition setting unit 113 updates the setting value of the permission or prohibition of the transmission of the e-mail according to states of the radio buttons 57 and 58.

With such a configuration, the same effect as the first embodiment can be obtained.

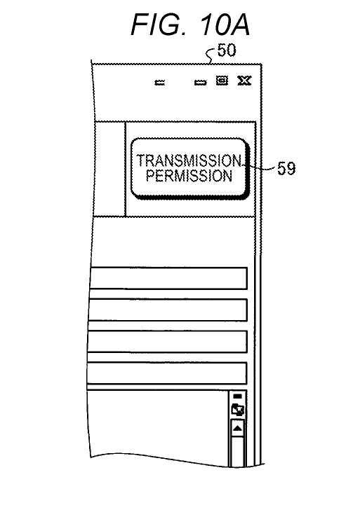

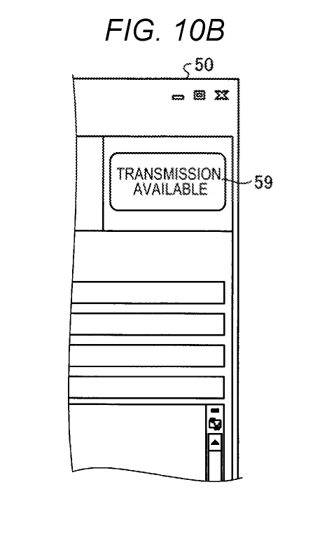

Next, FIGS. 10A and 10B are diagrams illustrating a GUI element used in an embodiment. Instead of the check box 54 in the first embodiment, a toggle button 59 may be used.

Whenever the toggle button 59 is operated, the permission or prohibition setting unit 113 switches the setting value of the permission or prohibition of the transmission of the e-mail from one of “permitted” and “prohibited” to the other. The toggle button 59 in a convex state shown in FIG. 10A indicates the “prohibited” state. The toggle button 59 in a concave state (or a flat shape) shown in FIG. 10B indicates the “permitted” state.

With such a configuration, the same effect as the first embodiment can be obtained.

Although the UI 50 of the first and second embodiments is the GUI, in implementation, the UI 50 is not limited thereto. For example, the UI 50 may be applied to a Text User Interface (TUI).

### Third Embodiment

The third embodiment will be described below. Since the present embodiment is a modification example of the first embodiment, the description of the same parts as the first embodiment will be omitted, the parts different from the first embodiment will be described, and in the description, the same reference numerals are used for those already described in the first embodiment.

In the present embodiment, a case of a web mail will be described. In the case of the web mail, in the client 10, a web browser functions as the mailer, and a web server is interposed between the mailer and the server 20.

In the first embodiment, the GUI displayed by the mail software that is the application software is described as an example. However, in the present embodiment, a disposition configuration similar to the UI 50 in the first embodiment is applied to a Web User Interface (WUI).

In a case of the WUI, the disposition configuration similar to the UI 50 of the first embodiment is configured in a web page so that the UI 50 is able to be referred in the web browser. Therefore, in the present embodiment, the web server provides the function corresponding to the permission or prohibition instruction unit 113, the transmission processing unit 114, or the like in the first embodiment to the client 10 through the web browser.

Although the details are omitted since the details are repetitive with respect to the description of the first embodiment, the web browser of the client 10 transmits and receives the e-mail to and from the server 20 that is the mail server through the web server.

With such a configuration, the same effect as the first embodiment can be obtained.

The information processing apparatus of an embodiment includes a processor such as a CPU, a memory such as a ROM or a RAM, an external storage device such as an HDD or a CD drive device, a display device such as a display, and an input device such as a keyboard or a mouse, and is configured of a hardware configuration using a general purpose computer.

A program executed by the information processing apparatus of an embodiment is recorded in a non-transitory computer-readable recording medium such as a CD-ROM, a Flexible Disk (FD), a CD-R, and a Digital Versatile Disk (DVD) in a file of a format that can be installed or executed and is provided.

The program executed by the information processing apparatus of an embodiment may be stored on a computer connected to a network such as the Internet and provided by a download through the network. The program executed by the information processing apparatus of an embodiment may be provided or distributed through the network such as the Internet.

The program of an embodiment may be stored in a ROM or the like in advance and provided.

The program executed by the information processing apparatus of an embodiment includes a module configuration including each of the units described above (the UI provision unit 111, the operation reception unit 112, the permission or prohibition setting unit 113, the transmission processing unit 114, the reception processing unit 115, the save processing unit 116, and the storage management unit 117). The CPU (the processor) reads and executes the program to load each of the units described above. Therefore, the UI provision unit 111, the operation reception unit 112, the permission or prohibition setting unit 113, the transmission processing unit 114, the reception processing unit 115, the save processing unit 116, and the storage management unit 117 are generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an input device;
a display; and
a processor configured to:
control the display to display a graphical user interface (GUI) including:
a first GUI element selectable for transmitting a message; and
a second GUI element for switching a first state where the first GUI element is operable and a second state where the first GUI element is not operable;
control the input device to accept a user input for switching the first and the second state on the second GUI element; and
control the display to display the first GUI element as being not operable in the second state.

2. The information processing apparatus according to claim 1, wherein the first GUI element is displayed at an opposite side of the second GUI element in the GUI.

3. The information processing apparatus according to claim 1, wherein the first and the second GUI element have different appearances.

4. The information processing apparatus according to claim 1, wherein the processor controls the display to display the first GUI element as being not operable when the GUI is displayed in response to a user input for starting to edit a saved message or create a new message.

5. The information processing apparatus according to claim 1, wherein the second GUI element is a checkbox.

6. The information processing apparatus according to claim 1, wherein the second GUI element includes two radio buttons.

7. The information processing apparatus according to claim 1, wherein the second GUI element is a toggle button.

8. The information processing apparatus according to claim 1, wherein the first GUI element is a button that is grayed out in the second state.

9. The information processing apparatus according to claim 1, wherein the processor control the display to display the GUI for a mail application that operates on the information processing apparatus.

10. The information processing apparatus according to claim 1, wherein the processor control the display to display the GUI for a web browser that operates on the information processing apparatus.

11. An information processing method carried out by an information processing apparatus, the method comprising:
displaying on a display a graphical user interface (GUI) including:
a first GUI element selectable for transmitting a message; and
a second GUI element for switching a first state where the first GUI element is operable and a second state where the first GUI element is not operable;
accepting via an input device a user input for switching the first and the second state on the second GUI element; and
displaying the first GUI element as being not operable in the second state.

12. The information processing method according to claim 11, wherein the first GUI element is displayed at an opposite side of the second GUI element in the GUI.

13. The information processing method according to claim 11, wherein the first and the second GUI element have different appearances.

14. The information processing method according to claim 11, wherein said displaying the first GUI element comprises displaying the first GUI element as being not operable when the GUI is displayed in response to a user input for starting to edit a saved message or create a new message.

15. The information processing method according to claim 11, wherein the second GUI element is a checkbox.

16. The information processing method according to claim 11, wherein the second GUI element includes two radio buttons.

17. The information processing method according to claim 11, wherein the second GUI element is a toggle button.

18. The information processing method according to claim 11, wherein the first GUI element is a button that is grayed out in the second state.

19. The information processing method according to claim 11, wherein the GUI is displayed for a mail application that operates on the information processing apparatus.

20. A non-transitory computer readable medium storing a program causing a computer to execute a method of controlling an information processing apparatus, the method comprising:
displaying on a display a graphical user interface (GUI) including:
a first GUI element selectable for transmitting a message; and
a second GUI element for switching a first state where the first GUI element is operable and a second state where the first GUI element is not operable;
accepting via an input device a user input for switching the first and the second state on the second GUI element; and
displaying the first GUI element as being not operable in the second state.
